(19) United States
(12) Patent Application Publication
(10) Pub. No.: US 2026/0028207 A1
(43) Pub. Date: Jan. 29, 2026

(54) IMPROVED WINCH DRUM AND A WINCH WITH SUCH A WINCH DRUM

(71) Applicant: Seldén Mast AB, Västra Frölunda (SE)

(72) Inventors: Jan KARLSSON, Västra Frölunda (SE); Christer BERNSON, Västra Frölunda (SE)

(21) Appl. No.: 19/099,130

(22) PCT Filed: Sep. 22, 2023
(86) PCT No.: PCT/SE2023/050932

§ 371 Date: Jan. 28, 2025

(30) Foreign Application Priority Data
Oct. 7, 2022 (SE) 2251174-5

(51) Int. Cl. B66D 1/30; B66D 1/74

(52) U.S. Cl. CPC B66D 1/30; B66D 1/7494

(57) ABSTRACT

Winch drum (10) for rotation about a rotation axis and comprising a line receiving outer surface (11) with a number of protrusions or ribs (1A1-1A9) extending substantially from an upper end of the winch drum towards a lower end of the winch drum (10). The ribs or protrusions (1A1-1A9) are asymmetrically distributed. The invention also relates to a winch (100) with such a winch drum (10).

### TECHNICAL FIELD

The present invention relates to an improved winch drum for a winch having the features of the first part of claim 1. Particularly the invention relates to an improved winch drum for a sailing boat winch. The invention also relates to a winch comprising such a winch drum.

### BACKGROUND

Winches are used on sailing boats for handling sails allowing e.g. controlling the tensioning and length of line and rope ends of a line or rope attached to an, on a fixed element, rotatably arranged winch drum. The sails are attached to lines, ropes or wires holding them in place and applying tension to the sails and supporting e.g. the mast. The lines, ropes or wires, are denoted differently depending on location and function or attachment such as headstay, backstay, shrouds, sheets, halyards, etc.

A winch traditionally comprises a winch body arranged to secured to e.g. a boat deck and a rotatable winch drum of a cylindrical cross-sectional shape arranged coaxially with the winch body and rotatable around a vertically disposed rotation axis for taking up line or rope (in the following denoted line for reasons of simplicity) running a number of turns around the winch drum.

In order to be able to sheet in large sails with a winch, particularly in strong winds, a high drum speed of the winch is needed to allow sheeting large sails in a short time, and also a high torque is required to allow tensioning of the sail when the wind is strong. A sailboat winch thus often needs to provide a high drum speed (at a low drum torque) as well as a high drum torque (at a low speed) and the loads in the line when pulling in line or releasing line are high, requiring a good grip between line and winch drum, and the wear on the line may constitute a severe problem.

Several solutions have been suggested to solve the problems associated with providing a satisfactory line gripping capability at the same time as reducing wear of the line.

Winch drums are known which have a smooth line gripping drum surface. However, line slippage then poses a large problem. In order to increase the frictional grip between winch drum and line, winch drums are known which have an irregular drum surface, e.g. a blasted or knurled surface. However, line wear will then be excessive.

Winch drums are also known which are provided with a plurality of U-shaped or V-shaped grooves axially extending substantially vertically at radially spaced intervals in the winch drum surface at a certain distance from each other. In U.S. Pat. No. 5,947,451 such recesses are arranged to extend in a helical way with respect to the rotation axis of the drum.

In WO94/06710 a winch drum with axially extending recesses at radially spaced intervals on the drum surface wherein the recesses are separated from each other through land sections, is disclosed. An object is to allow both controlled and forced slippage of a sheet line about the winch drum e.g. when paying-out and increasing grip circumferentially, which is desirable, more than increasing grip axially since increasing grip axially tends to prevent a desirable axial displacement of the coils or line turns along the winch drum. However, the gripping capability will be poor for modern hard lines and recesses or grooves are not suitable for modern lines which are too hard for the grooves or recesses to serve a purpose since the line will not bend or sink in into the recesses.

WO84/02511 discloses a winch drum with axially extending ribs at radially spaced intervals on the drum surface. However, when line or rope is released, and particularly under force, this will be associated with jerks or line jumps since the line has been deformed by the protrusions and line loops tend to be bunched at the top of the winch drum when the line is fed down the drum. The jerks particularly occur when line or rope has been deformed due to ribs or similar on the winch drum, and, during the release, the line cannot slide smoothly, a rib or protrusion will lock the position of the line or rope by a previous line imprint or deformation being engaged with a winch drum protrusion until the force is sufficiently high whereupon the line will rotate a distance and hence perform jerk or jump whereupon the subsequent line intrusion or deformation will engage with a subsequent drum protrusion where it is again locked until the next jerk etc., and, in addition, the ribs tend to brake the line since the load on the line will be uneven and concentrated in the same regions of the line. The occurrence of jerks, which in addition to be annoying, uncomfortable and loud, also lead to a risk that line is lost during release, which may have serious consequences and lead to damages, accidents and injuries.

SE 1051170 A1 discloses a winch drum with protrusions or ribs axially extending at radially spaced intervals on the drum surface, wherein the widths of the ribs increase downwards towards the lower end of the winch drum and through which a good controllability is provided, a good line gripping when pulling in rope under force and a low line wear. However, the problems associated with release of line resulting in jerks, a too high vertical or axial friction preventing a soft sliding upwards, are not solved.

Thus, all so far suggested winch drums suffer from drawbacks and there is no satisfactory solution to the problems associated with providing a winch drum providing a sufficient gripping capability for pulling in and pulling out line or rope at the same time as line wear is kept as low as possible and through which line can, in addition to be sheeted in, also be sheeted out in a safe and satisfactory manner.

### SUMMARY OF THE INVENTION

It is therefore an object of the present invention to provide a winch drum through which one or more of the above-mentioned problems can be solved.

A particular object is to provide a winch drum through which release of line is facilitated and in particular control at release of line is improved. It is particularly an object to provide a winch drum through which sheeting out of line can be performed in a smooth and comfortable manner.

It is also a particular object to provide an improved winch drum providing a sufficient gripping capability for sheeting in and sheeting out line at the same time as line wear is low and through which line can be sheeted out in a safe manner.

Most particularly it is an object to provide a winch drum through which gripping with respect to applied force in the line and line wear is optimized such that the wear is as evenly as possible distributed along the line and further the variation in load on the line is reduced and substantially independently of where on the drum the line is in contact with the drum surface.

It is also a particular object to provide a winch drum through which the controllability of line release can be increased during high loads.

Further yet it is an object to provide a winch drum which is easy and cheap to fabricate.

It is therefore an object of the present invention to provide a winch drum through which one or more of the above-mentioned problems can be solved.

Therefore a winch drum as initially referred to is provided which has the characterizing features of claim 1.

It is also an object to of the present invention to provide a winch through which one or more of the above mentioned problems can be solved.

A particular object is to provide a winch which is easy and safe to operate.

It is also an object to provide a winch which is reliable, smooth and silent in operation and through which uncomfortable jerks are avoided, in particular also in situations with high loads when sheeting out line.

Therefore a winch as initially referred to is provided having the features of the characterizing part of claim 20.

Advantageous embodiments are given by the respective appended dependent claims.

### BRIEF DESCRIPTION OF THE DRAWINGS

The invention will in the following be further described, in a non-limiting manner, and with reference to the accompanying drawings, in which:

FIG. 1 is a schematic view in perspective of a known winch with a winch drum with evenly distributed protruding ribs,

FIG. 1A is a schematic cross-sectional view through the winch drum taken along the section A0-A0 in FIG. 1,

FIG. 2 is a side view in perspective of a winch with a winch drum with asymmetrically distributed protruding ribs according to a first embodiment of the invention,

FIG. 2A is a schematic cross-sectional view through the winch drum in FIG. 2 taken along the section A1-A1 in FIG. 2,

FIG. 3 is a schematic view in perspective of a winch with a winch drum with asymmetrically distributed protruding ribs according to the invention with line wound about the drum,

FIG. 3A is a schematic side view of part of the winch shown in FIG. 3,

FIG. 3B is a cross-sectional view through the winch drum taken along the section A-A in FIG. 3A showing a section of the line wound around the drum when a constant force is applied, e.g. during sailing,

FIG. 3C is a cross-sectional view through the winch drum taken along the section A-A in FIG. 3A when line is released, line is sheeted out,

FIG. 4 is a schematic enlarged cross-sectional view of an alternative embodiment of a rib or protrusion of a winch drum according to the invention,

FIG. 5 is a schematic enlarged cross-sectional view of another alternative embodiment of a rib or protrusion of a winch drum according to the invention,

FIG. 6 is a schematic enlarged cross-sectional view of still another alternative embodiment of a rib or protrusion of a winch drum according to the invention,

FIG. 7 is a schematic side view of a winch drum with asymmetrically distributed protruding ribs which are tapering according to yet another embodiment of the invention,

FIG. 7A is a schematic cross-sectional view through the winch drum in FIG. 7 taken along the section B1-B1,

FIG. 7B is a schematic cross-sectional view through the winch drum in FIG. 7 taken along the section B2-B2,

FIG. 8 is a schematic side view of a winch drum with asymmetrically distributed protruding twisted ribs according to yet another embodiment of the invention,

FIG. 8A is a schematic cross-sectional view through the winch drum in FIG. 8 taken along the section C1-C1, and

FIG. 8B is a schematic cross-sectional view through the winch drum in FIG. 8 taken along the section C2-C2.

### DETAILED DESCRIPTION

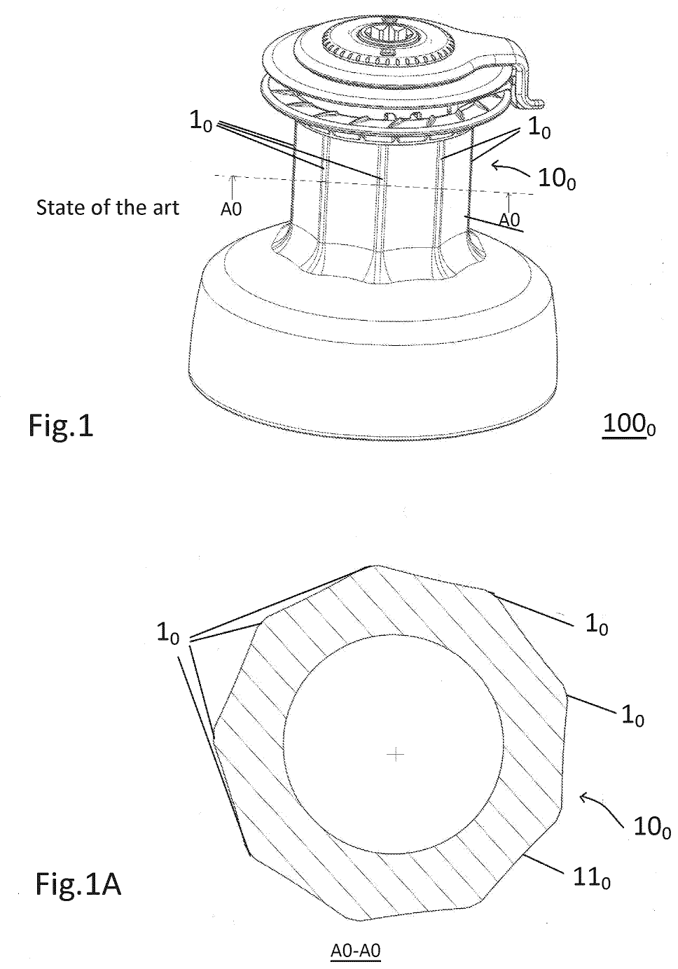

FIG. 1 shows a state-of-the-art example of a winch 100₀ for mounting on the deck of a sailing boat. The winch 100₀ comprises a winch drum 10₀ arranged to be rotatable around a rotation axis in a manner known per se. The winch drum 10₀ comprises a line receiving outer drum surface 11₀ which is provided with a number of substantially axially extending ribs or protrusions 1₀ which are disposed at regular radial distances from each other around the drum 10₀. The protrusions or the ribs 1₀ may have a constant width or their widths may vary in an axial direction and increase towards the lower part of the winch drum 10₀.

FIG. 1A is a cross-sectional view through the winch drum 10₀ taken along the section A0-A0 in FIG. 1.

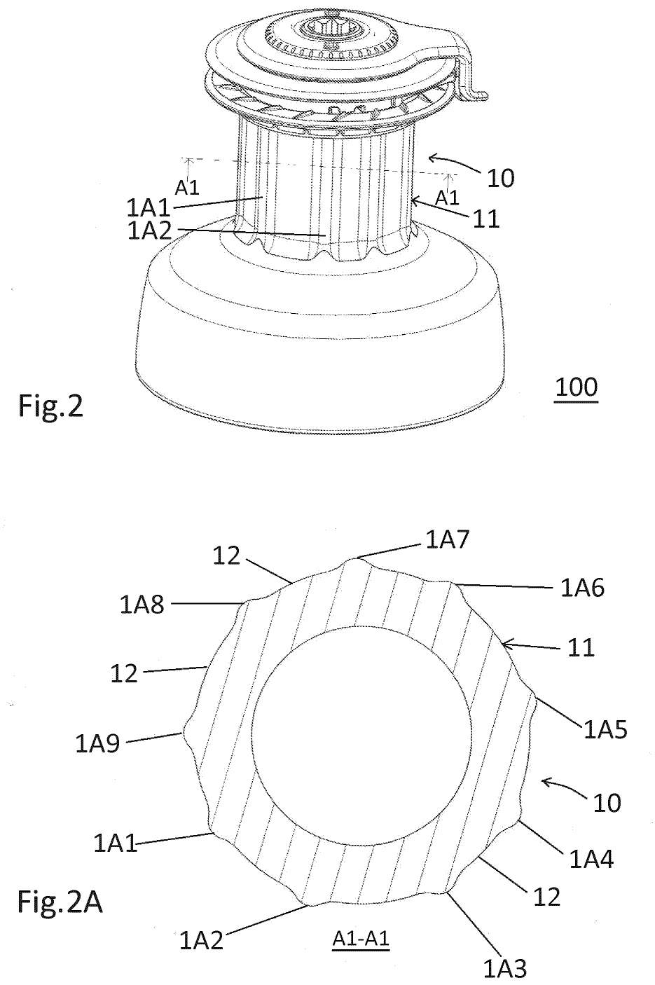

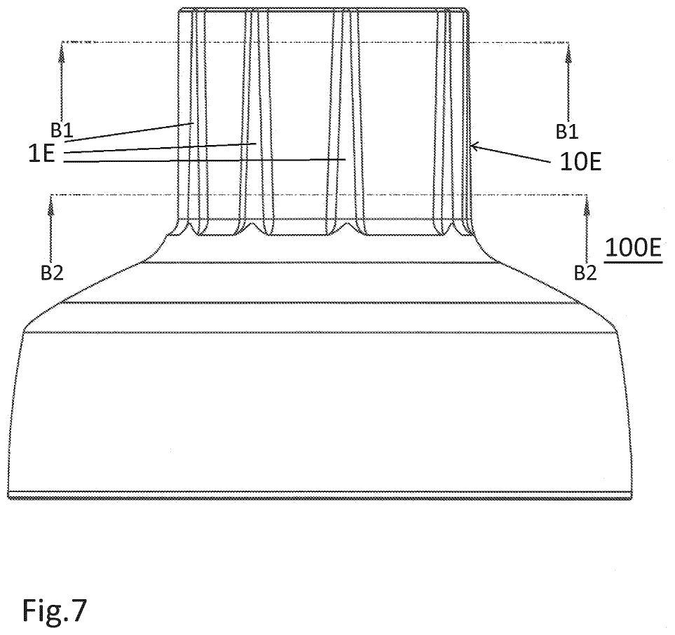

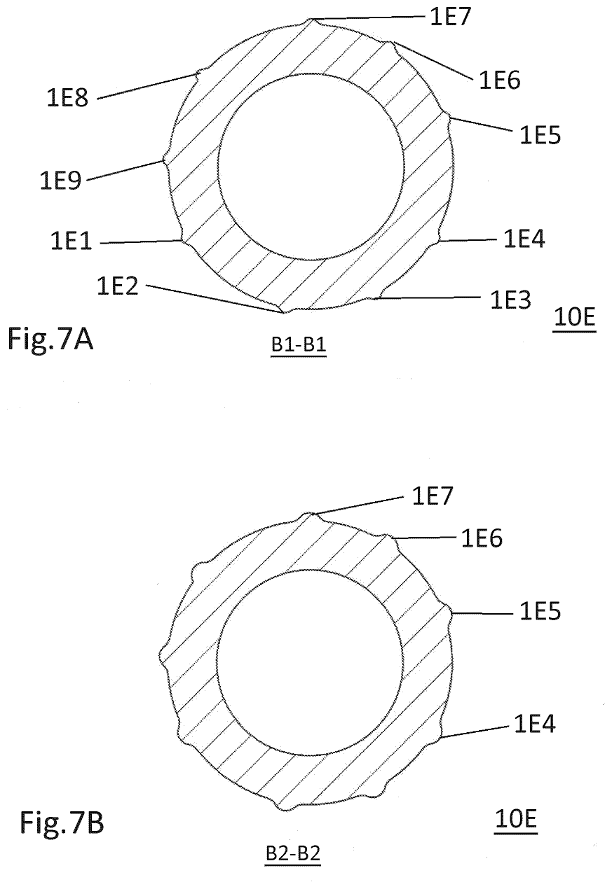

FIG. 2 shows a first embodiment of a winch 100 according to the present invention e.g. for mounting on the deck of a sailing boat. The winch 100 comprises a winch drum 10 arranged to be rotatable around a rotation axis in a manner known per se. The winch drum 10 comprises a line receiving outer drum surface 11 which is provided with a number of substantially axially extending ribs, ridges or protrusions 1A1,1A2, . . . 1A9 (in the following simply denoted ribs although it can be any kind of ribs, ridges or protrusions) which are disposed at irregular radial distances from each other around the drum 10. The protrusions or the ribs 1A1,1A2, . . . 1A9 here have a constant, and a similar, width. The widths may alternatively vary in an axial direction and e.g. increase towards the lower part of the winch drum 10 (see e.g. FIG. 7). In an alternative embodiment the ribs also have different widths. The ribs 1A1,1A2, . . . 1A9 are asymmetrically arranged and the distance or radial distance between each pair of ribs differs from the distance or radial distance between the subsequent formed pair of ribs, i.e. the distance between ribs 1A1 and 1A2 differs from the distance between ribs 1A2 and 1A3 etc. The distances may increase or decrease for subsequent formed pairs or decrease and increase in different alternating manners.

FIG. 2A is a cross-sectional view through the winch drum 10A taken along the section A1-A1 in FIG. 2. As can be seen from FIG. 2 the distance between ribs 1A1 and 1A2 is smaller than the distance between ribs 1A2 and 1A3, the distance between ribs 1A3 and 1A4 is even smaller, whereas the distance between ribs 1A4 and 1A5 is longer than the distance between ribs 1A3 and 1A4 etc.

The difference in radial distance between subsequent pairs of ribs may e.g. be 3-7 mm, e.g. the radial distance between a first pair of ribs may be 10 mm, the radial distance between the subsequent pair of ribs may be 15 mm, and the next subsequent pair of ribs be 20 mm. The sequence in radial differences may also be e.g. 10 mm, 5 mm and 17 mm or 7 mm, 18 mm and 12 mm. The figures are only given for exemplifying reasons and may of course take other values and vary in other manners. Any variation is in principle possible as long as the ribs are not arranged at radial distances from each other in a repeatable manner, or at least with respective, e.g. repetitive, groups, are asymmetrically distributed, and a line wound around it hence will not deformed in a regular manner through the ribs such that the line will not be “locked” or stuck due to previous deformations or imprints in the line by the drum protrusions, thus preventing or reducing the risk for jumps or jerks when line let out or when sheeting out. The number of ribs, as well as the size, shape and sharpness of the ribs may be different for different implementations, and also depend on implementation, expected loads or forces in the line, line material, size and properties of the lines to be used with the winch, diameter of the winch, the material of which the winch is made. Generally, the larger the winch drum diameter, the more ribs, e.g. for a winch drum having a diameter of 50-70 mm, there may be enough with e.g. 5-7 protrusions, whereas for a very large winch drum with a diameter of 200-400 mm, 20-30 ribs or more may be used. Generally, the sharper the edges of the ribs or protrusions, the better the better the gripping, but on the other hand, the risk of line jerks increases and the line wear increases with the sharpness. It is desirable to use as many ribs or protrusions as needed to reduce the contact area of the line with winch base surface 12, the surface between, void of, ribs, as much as possible. Generally the winch drum is made of stainless steel, Al (Aluminum), bronze plated Al. Other alternatives are also possible. The softer the material, the sharper protrusions or edges may need to be used. It should be clear that the numbers of ribs, diameters of winches and the relations given are mere given for exemplifying, and by no means for limitative, purposes.

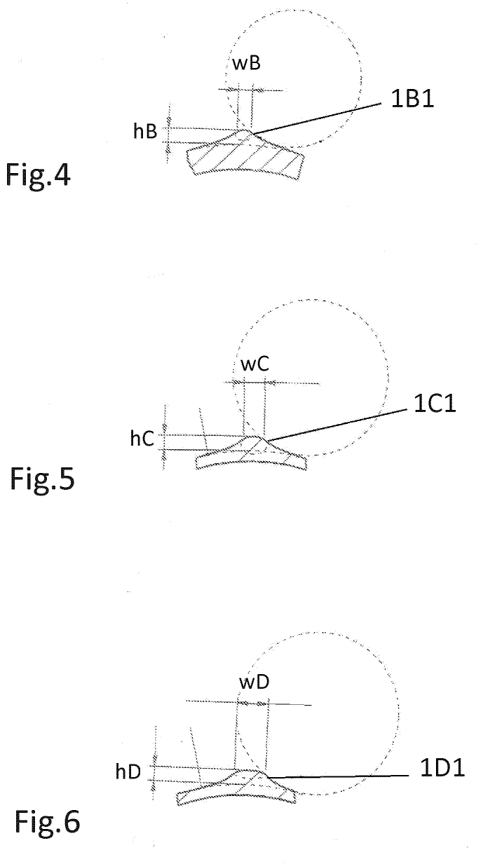

Some examples of different shapes of ribs or protrusions, width and/or rib sharpness, are illustrated for exemplary reasons and by no means for limitative purposes, in FIGS. 4-6 below.

In the embodiment shown in FIGS. 2, 2A the ribs (ridges or protrusions) 1A1-1A9 extend substantially axially from the upper end of winch drum 10 towards the lower end of the winch drum 10, substantially in parallel with the winch drum rotation axis. The ribs 1A1-1A9 may end at, or above or somewhat below the lower end of the winch drum base surface 11, or their widths may taper towards the upper end (see e.g. FIG. 7), or the distance they protrude from the surface may decrease towards the upper or lower end. Many variations are possible. There may also be a short transition zone at the lower end of the winch drum without any ribs.

In some embodiments, in which the diameter or the circumference of the winch drum 10 or the winch drum surface 11, varies somewhat in an axial direction, the height (the distance the ribs protrude from the winch drum base surface) may be adapted such that where the diameter or the circumference of the winch drum 10 increases, the height of the ribs decrease or vice versa such that the line receiving surface will have a substantially constant outer circumferential length or a constant diameter in an axial direction. In still other embodiments there is no such adaptation.

The gripping capacity can be varied from the lower part towards the upper portion of the winch drum. Through increasingly sharper edges towards the upper end of the winch, the gripping capacity will increase which can be advantageous since the force in the line is decreased for every turn when pulling in line; the force is highest on the first turn, at the lowest end of the winch drum. However, when line is release or let out, the risk for jumps or jerks somewhat increases.

The widths of the ribs 1A1-1A9 may be constant in the axial direction, alternatively, in some embodiments, the widths decrease somewhat in an upwards direction away from the surface, e.g. boat deck, on which the winch 100 is arranged.

In some embodiments, the winch drum, instead of having a cylindrical cross-section (in a direction perpendicular to the rotation axis), has a polygonal cross-section with e.g. between 8 and 15 sides, Then the ribs are then preferably arranged such that the ribs and the corners of the polygon are disposed asymmetrically.

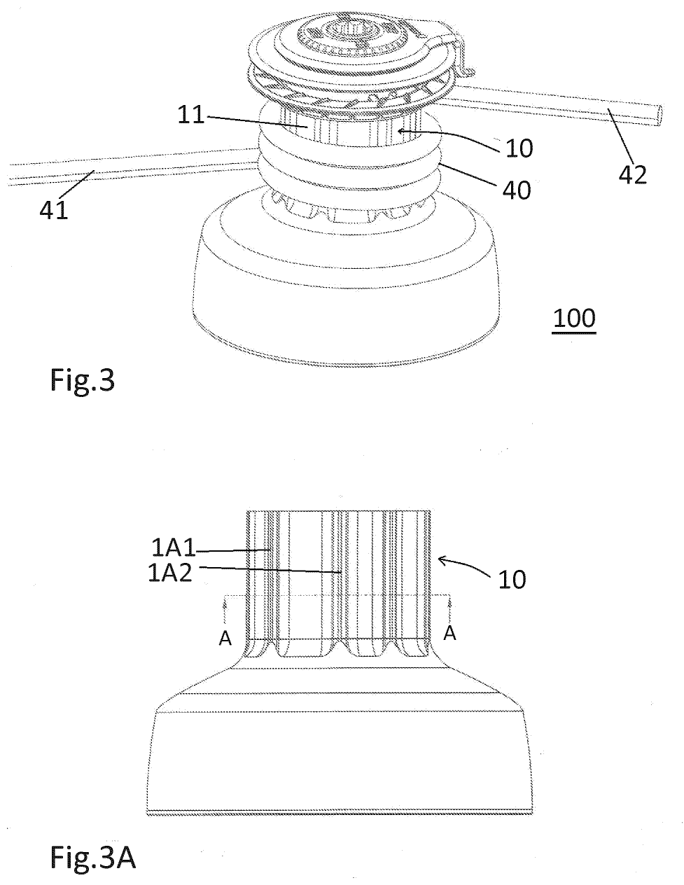

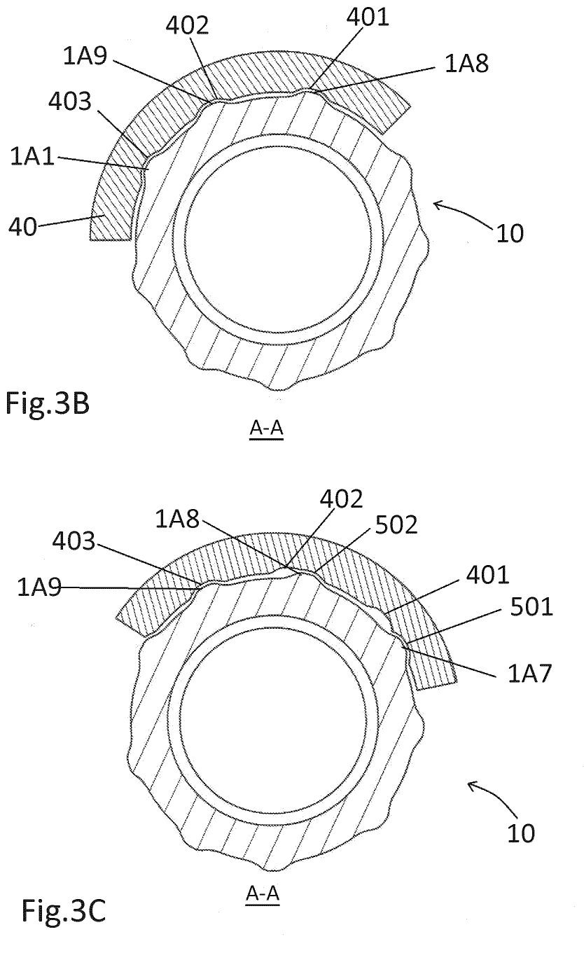

FIG. 3 is a view in perspective of winch 100 shown in FIG. 2 with a line 40 wound about the winch drum 10 and showing a line end 41 and a line end 42. In FIG. 3 it is supposed that a force is applied on winch end 41, which considerably exceeds the force applied on line end 42, e.g. 500 kN vs 5 kN to give an example merely for explanatory reasons. The other elements which have already been discussed with reference to FIG. 2 will not be further discussed here.

FIG. 3A is a schematic side view of winch 100 shown in FIG. 3 without any line wound about the winch drum 10, merely two of the ribs 1A1, 1A2 being schematically indicated.

In FIG. 3B which is a cross-sectional view through the winch drum 10 taken along line A-A in FIG. 3 showing a section of line 40 wound about the winch drum 10A and illustrating imprints or deformations 401, 402, 403 in the line 40 produced by e.g. protrusions 1A8, 1A9, 1A1 respectively in a state e.g. as shown in FIG. 3, e.g. during sailing under a certain load for some time period.

FIG. 3C, which also is a cross-sectional view through the winch drum 10A taken along line A-A in FIG. 3 showing a section of the line 40 wound about the winch drum 10A, but in a situation when line is sheeted out, i.e. the force applied in end 42 is reduced even more. Since the ribs are distributed located asymmetrically around the winch drum as discussed above, at least imprints 401,402 will not be located at locations of a subsequent positions where a rib 1A7,1A8 is forced under a high load against the line 40, and the line 40 will not be temporarily “stuck” due to previous imprints or deformations producing a jerk or jump when the line is released from ribs 1A7,1A8, i.e. a convenient misfit between protrusions and line imprints will result, preventing or at least reducing jumps or jerks when line is sheeted out, hence allowing a safer, smoother, more silent line sheet out operation, while also allowing a sufficient grip and reduced wear. In the shown embodiment one previous imprint 403 will be fitted to a subsequent rib 1A9, most important being that at least the majority of the other previous imprints do not.

FIG. 4 is a schematic cross-sectional view of a rib or protrusion 1B1 of a winch drum with e.g. nine axially around the winch drum asymmetrically distributed protruding ribs. The ribs 1B1, . . . , are as in the embodiment shown in FIG. 2 arranged asymmetrically at radially spaced apart intervals, but have a different shape than the ribs in FIG. 2. Rib or protrusion 1B1 has a height hB and a width wB. The width and the height is in one embodiment constant from the lower end towards the upper end of a winch drum. The width and/or the height may alternatively vary, e.g. from being wider at the lower end and narrower at the upper end and/or and having a smaller height at the lower end and having larger height at the upper end. All the ribs 1B1 . . . have a same height, hB and a same width wB (or variation in width and/or height). The width wB of rib or protrusion 1B1 is e.g. defined as the width that is formed at the point of intersection of a respective polygon vertices with side edges of the rib or protrusion. If the winch drum (not shown) in cross-section has the shape of a cylinder, the width of the rib or ridge 1B1 closest to the drum surface is defined as the length of a corda between two points of a circle formed where rib or ridge side walls cross the circle.

FIG. 5 is a schematic cross-sectional view of a rib or protrusion 1C1 of a winch drum with e.g. eight axially around the winch drum asymmetrically distributed protruding ribs. The ribs 1C1, . . . , are as in the embodiment shown in FIG. 2 arranged asymmetrically at radially spaced apart intervals, but have a different shape than the ribs in FIG. 2. Rib or protrusion 1C1 has a height hC and a width wC. The width and the height is in one embodiment constant from the lower end towards the upper end of a winch drum. The width and/or the height may alternatively vary, e.g. from being wider at the lower end and narrower at the upper end and/or and having a smaller height at the lower end and having larger height at the upper end. All the ribs 1C1 . . . have a same height, hC and a same width wC (or variation in width and/or height). The width wC of rib or protrusion 1C1 is e.g. defined as described above with reference to FIG. 4 but the width wC of the rib 1C1 is smaller than the width of rib 1B1. In the shown embodiment rib 1C1 tapers outwardly from the winch drum base surface. This merely relates to one particular embodiment; in other embodiments it does not, but preferably it is beveled or chamfered to further avoid a sharp edge damaging the line and to restrict line deformation.

FIG. 6 is a schematic cross-sectional view of a rib or protrusion 1D1 of a winch drum with e.g. ten axially around the winch drum asymmetrically distributed protruding ribs. The ribs 1D1, . . . , are as in the embodiment shown in FIG. 2 arranged asymmetrically at radially spaced apart intervals, but have a different shape than the ribs in FIG. 2. Rib or protrusion 1D1 has a height hD and a width wD. The width and the height is in one embodiment constant from the lower end towards the upper end of a winch drum. The width and/or the height may alternatively vary, e.g. from being wider at the lower end and narrower at the upper end and/or and having a smaller height at the lower end and having larger height at the upper end. All the ribs 1D1 . . . may have a same height, hD and a same width wD (or variation in width and/or height). The width wD of rib or protrusion 1D1 is e.g. defined as described above with reference to FIG. 4 but the height hD of the rib 1D1 is smaller than the height of rib 1B1 or rib 1C1, and the width 1wD is larger than the width of rib 1B1 and rib 1C1. Rib 1D1 tapers outwardly from the winch drum base surface. This merely relates to one particular embodiment; in other embodiments it does not, but preferably it is beveled or chamfered to further avoid a sharp edge damaging the line and to restrict line deformation.

FIG. 7 is a schematic side view of still another embodiment of a winch drum 10E of a winch 100E with asymmetrically distributed protruding ribs 1E1, . . . , 1E9 which are tapering towards the upper end of winch drum 10E.

FIG. 7A is a schematic cross-sectional view through the winch drum 10E in FIG. 7 taken along the section B1-B1 showing the protruding ribs 1E1, . . . , 1E9 arranged around the winch drum 10E, protruding from the winch drum surface 11E, axially in parallel with the winch 100E axis around which the winch drum 10E rotates, but irregularly radially disposed such that the distance between adjacent consecutive pairs of ribs varies. In addition, the width of each rib 1E1, . . . , 1E9 is smaller than the width of the rib 1E1, . . . , 1E9 at the lower location illustrated in FIG. 7B which is a schematic cross-sectional view through the winch drum 10E in FIG. 7 taken along the section B2-B2. The difference in width of a rib 1E1, 1E2, . . . , 1E9 at section B1-B1, towards the upper end of the winch drum 10E, and at section B2-B2, i.e. towards the lower end of the winch drum 10E may be between 2-5 mm. In one embodiment the width of a protrusion at a lower end is about 4-7 mm whereas the width towards the upper end of the winch drum is between 2-5 mm.

It should be clear that many variations are possible and depends on size and shape of the winch drum, used line, sharpness of edges and definition of width, the main things being that the ridges are asymmetrically distributed around the winch drum in a non-repetitive manner as discussed above, and that as little as possible of the line when wound about the drum is in contact with the intermediate surfaces between the ribs or protrusions, and the figures are merely given for exemplifying reasons.

It should be clear that the variation in width of a rib may be regular, continuous, or irregular and the variation in width can assume different values in different embodiments but also for different ribs of a winch drum.

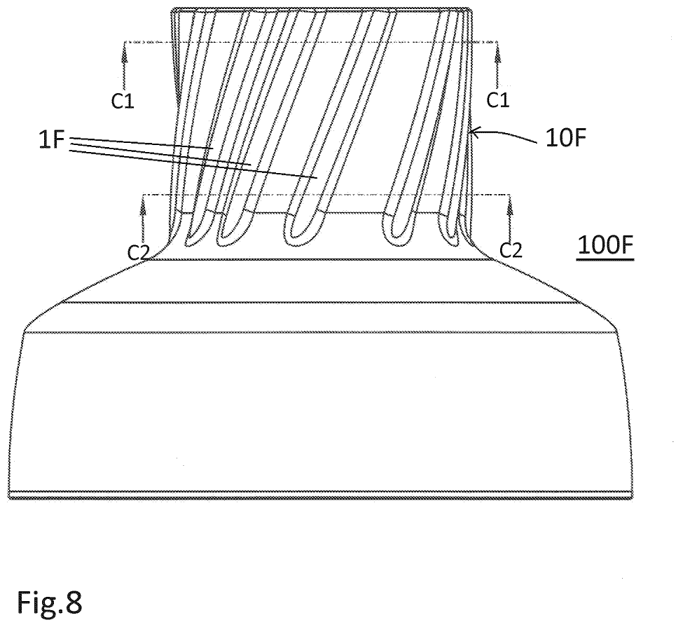

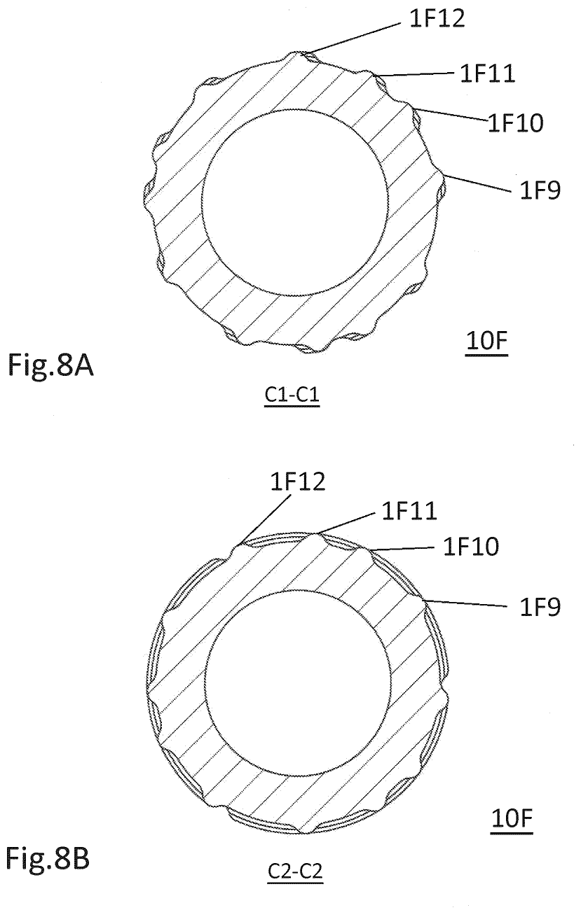

FIG. 8 is a schematic side view of a winch 100F with a winch drum 10F with twelve asymmetrically distributed protruding ribs 1F1, . . . ,1F12 arranged around the winch drum 10F and protruding from the winch drum surface 11F. The ribs 1F1, . . . , 1F12 are arranged in an inclined or twisted manner, here through an inclination angle of e.g. between 10°-35°, particularly 20°-25°, with respect to an axial line along the surface 11F, of the winch drum 10F in parallel with the rotation axis of the winch drum. The inclination angle may assume different values; preferably less than 45°. The ribs 1F1, . . . , 1F12 are here arranged in parallel, at irregular distances from each other and extend obliquely from the upper portion of the winch drum 10F, shown in FIG. 8A which is a cross-sectional view along the line C1-C1 in FIG. 8, to the lower portion of the winch drum 10F on the winch drum surface 11F shown in FIG. 8B which is a cross-sectional view along the line C2-C2 in FIG. 8.

The protruding ribs 1F1, . . . , 1F12 are so disposed that they form an angle with the winch 100F axis X around which the winch drum 10E rotates but irregularly, also here non-repetitively, such that the distance between adjacent consecutive pairs of ribs varies, and the ribs 1F1, . . . , 1F12 are at different positions at the lower location illustrated in FIG. 8B than at the upper position illustrated in FIG. 8A due to the inclination.

In the shown embodiment, assuming that line is wound on the winch drum in a clock-wise direction, the inclination assists in facilitating the line climbing upwards.

In an alternative embodiment (not shown) the ribs or protrusions are arranged in an inclined or twisted manner, here through an inclination angle of e.g. between −10°-−35°, particularly −20°- −25°, with respect to an axial line along the surface 11F, of the winch drum 10F in parallel with the rotation axis of the winch drum, i.e. the ribs or protrusions extend in an opposite direction to the ribs or protrusions in FIG. 8. In such an implementation, also for a clock-wise winding on the drum, is prevented that the line end is climbing upwards on the drum when line is let out.

It should be clear that the inclination angle may assume different values in different implementations, and may also be different for different ribs of a winch drum (not shown). Also, the larger the inclination angle, the effect of the inclination as discussed above, is enhanced (to a certain limit when the effect is lost, e.g. for an angle approaching) +/−45°.

In still other embodiments (not shown) the ribs or protrusions assume the shape of an inclined S or any other appropriate inclined shape.

It should be clear that the distances between subsequent pairs of ribs may assume many different values as also discussed above as long as the distance pattern between subsequent ribs is not repetitive, or at least not repetitive within respective groups. The difference between consecutive distances between ribs or protrusions differs and may in some embodiments be between +/−2-8 mm, preferably +/−3-7 mm, but it should be clear that these figures are only given for exemplifying reasons. The differences in distances may be smaller as well as larger.

In some embodiments the ribs are arranged in groups, which may be arranged in a repetitive manner around the winch, with at least three ribs in a group, the distance or radial distance between each pair of ribs differs from the distance or radial distance between the subsequent formed pair of ribs within the group. The number of groups is at least two, preferably three or more depending, e.g. on size and dimensions of the winch as discussed earlier in this application. In some implementations one or more extra ribs may be provided randomly between two or more of the groups. Also, in some implementation, within a group of at least four ribs, one of the distance between subsequent ribs might be repeated.

In general, the inventive concept is applicable for substantially any manually driven winch operated manually by means of a winch handle or winch crank, or is rotated by means of a line or rope pulled over the winch drum, but also for combined electrical/manual winches, two-speed winches etc. The inventive concept also is applicable for so called self-tailing winches with a self-tailing arrangement disposed at the upper end of the winch.

The winch drum is e.g. made of metal, e.g. stainless steel, e.g. marine grade stainless steel, Al, or anodized Al, in which the ribs or protrusions may need to be somewhat sharper than if it is made of stainless steel, of bronze, chrome plated bronze. The winch drum with protrusions may be made in one piece, alternatively the protrusions are made as separate elements securely connected to the winch drum. It should be clear that also other materials may be used; the winch drum may e.g. be made of a composite material. The ribs or protrusions are then preferably made of separate elements connected to or arranged in the drum surface.

A winch drum as described may be used in e.g. a manually and/or electrically and/or hydraulically driven winch.

It should be clear that the invention is not limited to the explicitly described embodiments but that it can be varied in several ways within the scope of the appended claims. The arrangement is particularly intended for use on a boat, particularly a leisure sailing boat.

It should also be clear that the content of described embodiments freely can be varied and combined. In the Claims:
Please enter the following claims as amended without prejudice:

1-22. (canceled)

23. A winch drum for rotation about a rotation axis and comprising:
a line receiving outer surface with a number of protrusions or ribs;
extending substantially from an upper end of the winch drum line receiving outer surface towards a lower end of the winch drum line receiving outer surface;
the ribs or protrusions are asymmetrically distributed;
the ribs or protrusions being disposed around the winch drum at radially spaced apart varying intervals; and
the intervals, or distances between ribs or protrusions varying in a non- repetitive manner, at least within respective groups comprising at least three protrusions or ribs or between consecutive groups of at least three ribs or protrusions.

24. The winch drum according to claim 23, wherein all protrusions or ribs are asymmetrically distributed, all the ribs or protrusions being disposed at radially spaced apart varying intervals, the intervals, or distances, between consecutive ribs or protrusions varying in a non-repetitive manner.

25. The winch drum according to claim 23, wherein the protrusions or ribs are asymmetrically distributed, the ribs or protrusions being disposed such that a line wound around it will not be deformed in a regular manner through the protrusions or ribs to prevent the line from being locked or stuck due to previous deformations or imprints in the line by the drum protrusions, thus preventing or reducing the risk for jumps or jerks when line is let out or when sheeting out, thus facilitating release of line and control at release of line.

26. The winch drum according to claim 23, wherein the winch drum and the ribs or protrusions comprise an integral element made in one piece.

27. The winch drum according to claim 23, wherein the ribs or protrusions are made of separate elements secured or attached to the winch drum hence forming part of the line receiving outer surface.

28. The winch drum according to claim 23, wherein at least the ribs or protrusions are made of metal, e.g. of stainless steel, e.g. marine grade stainless steel, of Al, of bronze, e.g. chrome plated bronze.

29. The winch drum according to claim 23, wherein it is made of metal, e.g. of stainless steel, e.g. marine grade stainless steel, of Al, or anodized Al, bronze, chrome plated bronze.

30. The winch drum according to claim 23, wherein it is made of a composite material.

31. The winch drum according to claim 23, wherein it has a substantially cylindrical cross-sectional shape.

32. The winch drum according to claim 23, wherein it has cross-sectional shape substantially in the shape of a polygon.

33. The winch drum according to claim 23, wherein the ribs or protrusions are substantially coaxially disposed with respect to the rotation axis around winch drum rotation axis.

34. The winch drum according to claim 23, wherein the ribs or protrusions have heights perpendicular to a base surface of the line receiving outer surface which are substantially constant with respect to said base surface through their extension from the upper end towards the lower end of the winch drum.

35. The winch drum according to claim 23, wherein the widths of the ribs or protrusions taper outwardly, in a radial direction, away from the winch base surface.

36. The winch drum according to claim 23, wherein the ribs or protrusions in a transverse cross section perpendicularly to a longitudinal extension of the ribs or protrusions, have an outwardly tapering shape forming an outer edge.

37. The winch drum according to claim 23, wherein it comprises the winch drum has a diameter between 50 mm-400 mm and in that it comprises between 4-30 ribs or protrusions preferably, for a winch drum having a diameter of 50-150 mm, between 5 and 8 ribs or protrusions, and for a winch drum having a diameter of 200-300 mm about 20-28 ribs or protrusions and for a winch drum having a diameter of 75-200 mm about 8-20 ribs or protrusions.

38. The winch drum according to claim 23, wherein the difference between consecutive distances between ribs or protrusions differs and is between +/−2-8 mm, preferably +/−−3-7 mm.

39. The winch drum according to claim 23, wherein the ribs or protrusions have widths which are constant and substantially the same at the upper end of the winch drum as at the lower end of the winch drum.

40. The winch drum according to claim 23, wherein the ribs or protrusions have widths which taper substantially continuously towards the upper end of the winch drum.

41. The winch drum according to claim 23, wherein the ribs or protrusions are obliquely or helically disposed.

42. A winch arranged to be mountable on the deck of a sailing boat comprising a winch drum according to claim 23.

43. The winch according to claim 42, wherein it is manually operable allowing manual rotation of the winch drum by means of a line pulled over the winch drum and/or electrically and/or hydraulically operable.

44. The winch according to claim 42, wherein it is a self-tailing winch.
